(19) United States
(12) Patent Application Publication
(10) Pub. No.: US 2019/0347601 A1
(43) Pub. Date: Nov. 14, 2019

(54) Peer-to-Peer Laundryshare Service Platform

(71) Applicant: Ahavel A. Aborishade, West Hollywood, CA (US)

(72) Inventor: Ahavel A. Aborishade, West Hollywood, CA (US)

(21) Appl. No.: 16/408,754

(22) Filed: May 10, 2019

Related U.S. Application Data
(60) Provisional application No. 62/669,620, filed on May 10, 2018.

(51) Int. Cl. G06Q 10/06; H04L 29/06

(52) U.S. Cl. CPC G06Q 10/063112; H04L 63/126; G06Q 10/063114

(57) ABSTRACT

Systems and methods directed to peer-to-peer laundrysharing are disclosed in this application. The inventive subject matter contemplates connecting individuals with laundry service needs (e.g., people that need garments washed, altered, or dry cleaned) with laundry service providers. A wide variety of different preferences and requirements can be taken into account in determining optimized matches between different users of the service platform, such as distance, the service needed, whether a pick-up or drop-off is required, etc. Service platforms of the inventive subject matter facilitate communication and service provision between individuals needing laundry services in ways never before contemplated.

This application claims priority to provisional patent application 62/669,620 filed May 10, 2018. All extrinsic materials identified in this application are incorporated by reference in their entirety.

### FIELD OF THE INVENTION

The field of the invention is a peer-to-peer laundryshare service platform.

### BACKGROUND

The background description includes information that may be useful in understanding the present invention. It is not an admission that any of the information provided in this application is prior art or relevant to the presently claimed invention, or that any publication specifically or implicitly referenced is prior art.

Laundromats across the nation use harsh chemicals to run machines that consume immense amounts of energy. Some laundromats are not safe and a majority of them are unsanitary, inconvenient to access. Many hold inconvenient hours, making it difficult to do a load of laundry late at night. While there has been a trend to mobilize laundromat and cleaning services, many of these mobilized services still share negative attributes with their predecessors. And while mobilized commercial cleaners exist, they often send unverified and unvetted individuals to your home to pick up laundry.

Most current commercial laundry service providers, even mobilized ones, are restricted by location, facility, and time. Most serve only a small radius and the quality of their work is often subpar—not to mention many of the other issues surrounding the use of unvetted individuals to do pick-ups and drop-offs.

Thus, there is still a need in the art for a peer-to-peer laundryshare service platform that allows users to directly connect with other users to gain access to various services at any time of day or night—directly from other, vetted individuals.

### SUMMARY OF THE INVENTION

The present invention describes peer-to-peer laundrysharing systems and methods. In one aspect of the inventive subject matter, a service platform system is contemplated. The service platform system comprises a server storing computer code, where, upon execution of the code, the server becomes configured to: receive first user preferences associated with a first user (e.g., a laundry client), the first user parameters comprising a required task; receive second user preferences associated with a second user (e.g., a washer, an alteration provider, or a dry cleaner), the second user parameters comprising a set of task capabilities; receive a request from the first user to connect with another user based on the first user preferences; identify the second user as a match for the first user based on at least the required task and the set of task capabilities; send a first communication to the first user, the first communication comprising a first indication that the second user and the first user have matching parameters; send a second communication to the second user, the second communication comprising a second indication that the second user and the first user have matching parameters; facilitate communication between the first user and the second user; receive a third indication from the second user that the required task has been completed; and send a fourth indication to the first user that the required task has been completed.

In some embodiments, the server is further configured to: receive, from the first user, a request to create an account comprising at least one of an email and a phone number; send, to at least one of the email and the phone number, a verification code; receive, from the first user, the verification code; and verify authenticity of the first user based on receipt of the verification code.

In another aspect of the inventive subject matter, a method directed to peer-to-peer laundrysharing is contemplated. The method includes the steps of: receiving, by a server, first user preferences associated with a first user (e.g., a laundry client), the first user parameters comprising a required task; receiving, by the server, second user preferences associated with a second user (e.g., a washer, an alteration provider, or a dry cleaner), the second user parameters comprising a set of task capabilities; receiving, by the server, a request from the first user to connect with another user based on the first user preferences; identifying, by the server, the second user as a match for the first user based on at least the required task and the set of task capabilities; sending, from the server, a first communication to the first user, the first communication comprising a first indication that the second user and the first user have matching parameters; sending, from the server, a second communication to the second user, the second communication comprising a second indication that the second user and the first user have matching parameters; facilitating, by the server, communication between the first user and the second user; receiving, by the server, a third indication from the second user that the required task has been completed; and sending, by the server, a fourth indication to the first user that the required task has been completed.

In some embodiments, the method further comprises the steps of: receiving, by the server from the first user, a request to create an account comprising at least one of an email and a phone number; sending, to at least one of the email and the phone number, a verification code; receiving, at the server from the first user, the verification code; and verifying, by the server, authenticity of the first user based on receipt of the verification code.

One should appreciate that the disclosed subject matter provides many advantageous technical effects including enabling peer-to-peer user matching in the context of laundry services.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a flowchart showing how individuals can become users and select roles within the service platform.

FIG. 2 shows how information flows between user devices and service platform servers.

FIG. 3 is a flowchart showing how a laundry client can use the service platform.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

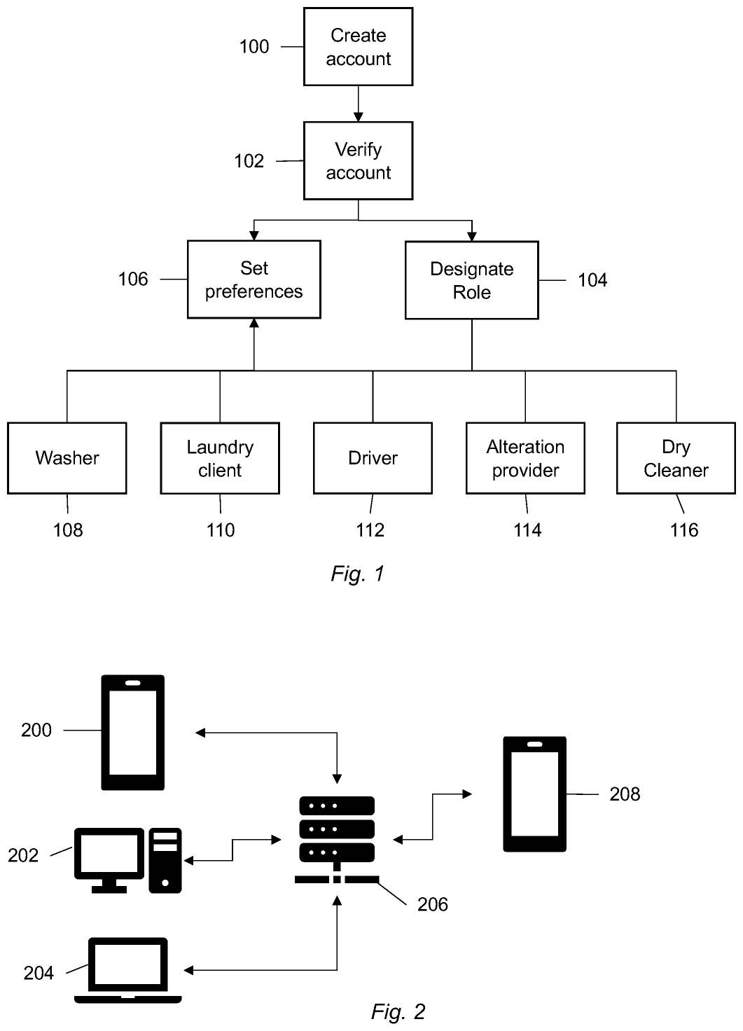

FIG. 1 shows a flowchart of an embodiment of the inventive subject matter, and FIG. 2 shows an example of communication pathways that different embodiments can implement. Embodiments of the inventive subject matter are implemented within a service platform. The service platform maintains one or more servers that coordinate peer-to-peer communications between users. It is contemplated that the service platform includes not just the one or more servers (shown as 206 in FIG. 2) As shown in FIG. 1, users (e.g., a person or entity that uses the service platform, regardless of their later-selected role within the service platform) begin by creating an account (step 100).

To create an account, a user is prompted to input one or more account identifiers (e.g., a username, an email account, a phone number, etc.) into a user interface (e.g., via an end-user application or a web browser). In some embodiments, users can set a language preference. A user thus accesses the service platform via a user's computing device (e.g., a mobile device 200, a desktop computer 202, a laptop computer 204, a tablet, or the like) by opening an app or a web browser, and they are then prompted to input an account identifier. The user then inputs an account identifier and, in some embodiments, inputs a password that can be used to access their account. The one or more account identifiers and the password are then transmitted from the user's computing device to a service platform server 206 where they are stored using appropriate security protocols so that the user can regain access to their account using an account identifier along with the associated password. In embodiments where a user provides a mobile phone number, the user's account can be verified by, for example, sending a text or SMS message with a one-time passcode that the user can use to verify their account. In some embodiments, a user's phone number can be used by the service platform to place a call to the user to give the user a code (e.g., a one-time passcode) that can be used to verify the user's account.

The server 206 thus receives account information (e.g., one or more account identifiers and an associate password) and a user account is created. User accounts can be stored in a database that is maintained by the server 206 and either stored on the server 206, stored on a remote server accessible to the server 206 by a network connection, or stored on some combination of the server 206 and a remote server.

Once a user creates an account, they can then verify the account, according to step 102. In some embodiments, this step can be skipped, though it is preferable that user accounts are verified. Account verification can be completed or facilitated in a number of different ways and can include verification of a user's identity and location. For example, users can be required to provide one or more of an upload of a government issued ID (e.g., a driver's license, passport card, passport, student ID, etc.), an upload of a bill verifying both identity and place of residence or business (e.g., to verify that a washer indeed exists at a specified location), a mobile phone number for two-factor authentication and to verify that the user has a smart phone compatible with the service platform, etc. Although verification can be completed in a general sense with respect to every user, it is also contemplated that additional verifications can be completed depending on a role or roles a user selects. Additional verifications are discussed below with respect to each role.

In some embodiments, users can also create and authenticate accounts by using a social media account, e.g., Google+, Facebook, Twitter, etc., which can allow the service platform to pull in user information from the user's social media account to collect some or all of information needed to create a user's account with the service platform.

In steps 104 and 106, a user having created a new account (and, in some embodiments, having verified that user account) can then select a designated role (step 104) and set their preferences (step 106). In some embodiments, selecting a designated role can be a part of setting user preferences in step 106. It has been shown as a separate step entirely in FIG. 1 for clarity. A variety of roles are contemplated, including washer 108, laundry client 110, driver 112, alteration provider 114, and dry cleaner 116. In some embodiments, users can select multiple roles at once, and roles can be changed on an as-needed basis. For example, if a user is both an alterations provider and needs a load of laundry done, they can select to be both a laundry client 110 and an alteration provider 114.

The step of setting preferences 106 allows a user to designate a wide variety of preferences that can affect how the user can interact with the service platform. In some embodiments, users can skip setting preferences and come back to it later. If user's elect not to set preferences at this stage, the service platform can caution the user that their matching results may be generic (e.g., a user that designates themselves as a laundry client may be matched with any washer instead of being matched with a washer that meets certain criteria set by the laundry client). User preferences can be set to indicate preferences for a particular user, but they can also be set to indicate a particular user's preferences in other users of the service platform. For example, a user can set a preference to only be shown washers within a certain radius of their current location (e.g., set by GPS or set by selecting a location). This is an example of a particular user's preference in the service platform. But a user can also set a preference to only be shown washers that have appliances able to handle large laundry loads. This is an example of a user's preference in other users of the service platform. It is contemplated that users can select multiple roles simultaneously (e.g., a driver can also be a laundry client).

In some embodiments, users can set payment preferences in step 106. For example, users can input debit/credit card information, mobile or online payment account information (e.g. PayPal, Venmo, Square Cash, etc.), or even cryptocurrency account information (e.g., Bitcoin, Ethereum, Litecoin, etc.) to facilitate payments.

There are a variety of different roles within the service platform, and each role can have different user settings. For example, washers 108 can define settings related to the appliances and services they are making available for use within the service platform. Washers can also be subject to additional verifications. For example, a washer can be required to input credit card information so that the service platform can match the billing address with the address the washer put into their profile. In some instances, the billing address for a credit card may not be the same as the address where the washer is located, and a washer and indicate this to the service platform to opt for a different form of address verification. In another embodiment a washer's address can be verified by post card. A post card can be mailed to the address the washer adds to their profile with a code that they must enter online or in the app. Washers can also be verified by an on-demand password. For example, an SMS or phone call comprising an on-demand password can be sent to the washer's phone number to be used to verify the washer. It is contemplated that, in some embodiments, Google Voice, Skype, or other “virtual” phone numbers cannot be used in the verification process.

In some embodiments, washers can be required to submit one or any combination of a driver's license, bank account info, SSN, address where their machines are located, etc. Laundry appliance verification can also be required (e.g., make and model), and a washers can also be required to submit a statement of current condition regarding their laundry appliances.

Washers 108 can indicate, for example, the type of appliances they have (e.g., a washer, a dryer, a combination of both, etc.), brands, models, serial numbers, capacities, capabilities, etc. Washers 108 can also indicate times they are available. This can be accomplished in a variety of ways. For example, in some embodiments, a washer 108 could input a range of times, while in other embodiments, a washer 108 could simply set a flag with the service platform to indicate their availability. Such a flag can be set by changing a status within an application indicating current availability and making the washer 108 visible to, e.g., laundry clients 110. When the flag is changed to indicate the washer 108 is no longer available, the washer 108 can be made invisible to prospective laundry clients 110. Washers can also indicate types of garments they are unwilling or unable to wash (e.g., intimate garments or garments made from or including certain materials) and types of detergents they have available for use. In some embodiments, washers can double as drivers, carrying out the same functions described below with respect to drivers, including an ability to indicate how far a washer is willing to travel to pick up a load of dirty laundry from a laundry client.

A washer 108 is an individual or entity that has laundry appliances. When a user designates themselves as a washer 108, they are indicating that they wish to make their laundry appliances available for use by other users of the service platform (e.g., users that designate themselves as laundry clients 110). It is contemplated that, to protect a washer's privacy and safety, other users may not ever actually enter a washer's premises instead dropping off or enlisting a driver to drop off, e.g., dirty laundry, and then picking up or enlisting a driver to pick up the clean laundry later. Users designated as washers can provide services including one or any combination of washing, folding, basic garment repairs/mending (e.g., small tear stitching, replacing buttons, hems, etc.), ironing, as well as steaming services.

In some embodiments, users that would like to be designated as washers 108 are vetted and verified using one or more forms of identification (e.g., a state issued driver's license or ID, a social security number, a student ID for student level/tier washers, a postcard with a code that is mailed to the user, etc.). In some embodiments, a washer's laundry appliances are also verified according to, for example, appliance details (e.g., brand, model, serial number, capacity, capability, etc.). Laundry clients 110 that are looking for a washer 108 can then be matched to a washer 108 according to, for example, distance (e.g., the closest available washer) to washer 108 along with the laundry client's preferences.

Washer can also supply loaner garments. For example, if someone spills coffee and needs their shirt washed immediately, that person (designated as a laundry client within the service platform) can identify a washer that also has a loaner garment that the laundry client can wear while their soiled garment is being washed. Laundry clients can indicate (e.g. in the course of requesting a washer) that they have a need for a loaner garment, and the service platform can then match the laundry client with washers that have loaner garments. In some embodiments, laundry clients can input garment sizes into their preferences so that the system can match them with washers that have the right sized loaner garments. In some embodiments, users can opt in to different tiers within the service provider (e.g., for a fee, either one-time or recurring) that enables those users to keep the loaner garments as their own in the event the loaner garment is needed.

As alluded to above, in some embodiments, users can be designated by default as laundry clients 110. Laundry clients 110 can similarly set preferences. When a laundry client 110 is in search of a service provider (e.g., a dry cleaner 116, an alteration provider 114, a washer 108, etc.) within the service platform, they may indicate certain requirements they may have for that service provider. For example, when a laundry client 110 is looking for a washer 108, the laundry client 110 may indicate that they only want to find washers 108 that have certain appliances (e.g., a dryer capable of timed drying or auto-drying, a washing machine capable of washing delicate garments at different temperatures, or a washer 108 that is able to iron or steam out wrinkles, etc.). In some embodiments, a laundry client 110 may be looking for an alteration provider 114 capable of providing a specific service (e.g., hemming, fixing buttons, mending, ironing, etc.). In such situations, the laundry client 110 can set preferences to only be shown alteration providers 114 that are capable of completing the task the laundry client 110 needs. In some embodiments, laundry clients 110 can set a rating preference so that they are only shown drivers, alteration providers, dry cleaners, and washers that meet certain rating thresholds (e.g., only show those other roles when their rating is above 80%). In some embodiments, laundry clients can also set washing chemical preferences (e.g., scented/unscented detergents, bleach types, etc.). Washers can also indicate whether they are willing to provide loaner garments, and if they are, they can additionally provide information regarding the loaner garments they have available (e.g., size, color, garment type, etc.).

Laundry clients can set a variety of other preferences related to special needs. For example, a laundry client can indicate whether they have a disability requiring assistance to, e.g., lift items. Laundry clients can also indicate a language and language preferences for other users that they interact with (e.g., Spanish speakers can indicate they prefer to be paired with other Spanish speakers). In some embodiments, users can indicate to the service platform that they are able to communicate in sign language (e.g., ASL, PSE, and SEE), and those users can indicate a preference for communication using sign language. In some embodiments, the service platform can facilitate text communications between users that speak different languages by providing automatic translation. Automatic translation can be facilitated by users indicating their language preferences so the service platform can translate from one user's language to another user's language based on each user's indicated language preference.

In some embodiments, users (e.g., laundry clients) may need to input their body measurements to the service platform to facilitate, e.g., alterations. It is contemplated that some embodiments of the service platform can incorporate digital body measurements using, e.g., a smart phone's cameras. These measurements can then be stored for each user. Users can alternatively manually input some or all measurements to their account with the service platform.

Users can also elect to be drivers 112 for the service platform, and when a user elects to be a driver 112, they can set driver preferences. Drivers 112 for the service platform can be summoned by other users of the service platform to perform pick-up (e.g., picking up dirty or clean laundry) and drop-off tasks (e.g., dropping off dirty or clean laundry). Drivers can set their current location (e.g., by using a computing device's onboard sensors to determine location, by setting a location manually, etc.) as well as a vehicle type, a maximum capacity based on vehicle type, a language preference, and a willingness to assist with, e.g., carrying laundry loads or other physical labor tasks that may arise in the course of carrying out a driver-related task. Driver 112 preferences can also include a preferred range for pick-up, drop-off, and courier services for the service platform. For example, a driver can indicate that they only want to pick up and drop off laundry if the pick-up or drop-off location is within, e.g., 10 miles of the driver's current location or of a set location, or any variation of that scenario. Drivers can set a maximum drive distance, e.g., for a day, for a pick-up/drop-off trip, for a duration of time, etc.

In some embodiments, a driver 112 can set a desired start location (e.g., a location that does not necessarily coincide with the driver's current location where the driver would like to begin doing pick-ups and drop-offs) and a desired end location (e.g., a location that does not necessarily coincide with the driver's current location where the driver would like to conclude doing pick-ups and drop-offs). Drivers 112 can additionally define a geographic region in which they would like to do pick-ups and drop-offs. A geographic area can be manually defined on a map (e.g., by allowing a driver to draw a region in which they'd like to operate) but it can also be defined by, e.g., selecting one or more or any combination of a city, state, county, neighborhood, etc.

Another role a user can take on is as an alteration provider 114, and when a user elects to be an alteration provider 114 they can set preferences specific to that role. An alteration provider 114 can set a location for their services, they can indicate that their services are mobile (e.g., the alteration provider 114 can go to a location to do an alteration), they can list out alteration capabilities (e.g., hemming, sewing, alterations, etc.), they can list out equipment they have available to do different jobs (e.g., sewing machines, pressing machines, etc.), and they can list out specializations (e.g., specializations in a particular types of garment like wedding dresses and suits and specializations in particular services such as hemming and alterations, etc.). In some embodiments, alteration providers can make home visits to other users to carry out tasks such as measurements and doing fittings for other users. Alteration providers can indicate ability and willingness to do home visits in their preferences.

Users can also set a preference to designate themselves as a dry cleaner 116. Dry cleaner 116 preferences largely overlap with many of the preferences available for other roles within the service platform. For example, when a user designates themselves as a dry cleaner 116, they can then set: a location for their services, dry cleaning capabilities, dry cleaning materials and chemicals that they use (e.g., they can indicate whether their chemicals are environmentally friendly), dry cleaning equipment that they use, average turnaround time for dry cleaning, etc. In some embodiments, dry cleaners can also set preferences indicating hours of operation.

Dry cleaners 116 can set additional preferences to indicate add-on services. For example, dry cleaners 116 can indicate whether they offer (e.g., complimentary) pick-up and drop-off as a part of their service. In some instances, dry cleaners 116 also offer alteration services, and to indicate this to other users, dry cleaners can select multiple roles.

To function, the service platform needs at least one laundry client and at least one washer, thereby allowing the at least one laundry client to be paired with the at least one washer to get a load of laundry done. Users can access the service platform via, e.g., a mobile app, a desktop app, a web browser, etc., and, after going through the steps described above in relation to FIG. 1, users can then begin using the service platform. For each user type, the user experience can be different.

In one scenario, a user is a laundry client. In such a situation, the laundry client accesses the service platform via a computing device such as a mobile phone (e.g., mobile phone 200 as shown in FIG. 2). The laundry client can then provide an input to the service platform via their mobile phone indicating that they are looking for a nearby washer. The laundry client's inputs are relayed from the user's device (e.g., 200, 202, or 204) to a server 206. The server 206 can then conduct a search based on the laundry client's preferences to identify a washer that best fits the laundry client's needs. A washer thus also accesses the service platform using a mobile device 208 (it is contemplated that the mobile device 208 as described anywhere in this application can also be any other type of internet connected computing device such as a PC, laptop, tablet, etc.), and when the server 206 identifies that washer as being a good fit for the laundry client, it alerts the washer of the laundry client's needs and connects the two. Connecting two users that the server 206 has matched together can include facilitating communication between the two users, either by allowing the users to directly communicate with each other or by allowing the users to communicate with each other using the server as a proxy to protect each user's privacy.

When the service platform has identified a washer for a laundry client, the laundry client can then either drop off their laundry with the washer themselves, or the service platform can additionally coordinate for a driver to act as a courier. When a laundry client has set a preference to identify that they prefer to have their laundry picked up and dropped off by a driver, the server 206 can, in some embodiments, additionally identify a nearby driver (e.g., according to the laundry client's preferences, if applicable) that can pick up the laundry client's laundry.

After the washer has finished with the laundry client's laundry, the washer can send information to the server 206 sufficient to indicate that the laundry is done and available for pickup. In some embodiments, the server can relay that status back to the laundry client. If the laundry client has set a preference indicating a desire for the completed laundry to be picked up to be delivered back to the laundry client, then the server 206 can immediately begin to identify a new driver that can go pick up the laundry. In some embodiments, the server 206 can deliver a message to the laundry client's device (e.g., 200, 202, or 204) indicating that the laundry has been completed and give the laundry client a list of options for retrieving the laundry, including delivery by driver or retrieval by the laundry client. The laundry client can then make a selection that is sent back to the server 206, and the server 206 can alert the washer of the laundry client's selection (e.g., by sending a message to the washer's device 208) and react accordingly (e.g., by identifying a new driver to pick up and then drop the laundry off with the laundry client or by simply letting the washer know that the laundry client will be coming to get their laundry).

In another scenario, a user is a laundry client in search of a dry cleaner. In such a situation, the laundry client accesses the service platform via a computing device such as a mobile phone (e.g., mobile phone 200 as shown in FIG. 2). The laundry client can then provide an input to the service platform (e.g., server 206) via their mobile phone 200 indicating that they are looking for a nearby dry cleaner. The laundry client's inputs are relayed from the user's device (e.g., 200, 202, or 204) to a server 206 so that the server 206 can conduct a search based on the laundry client's preferences to identify a dry cleaner that best fits the laundry client's needs. In some embodiments, when the laundry client identifies that they need a dry cleaner, the server 206 can send one or more questions to the laundry client's device (e.g., 200, 202, or 204) to collect additional information (e.g., what type of stain is to be cleaned, what type of material is to be cleaned, etc.). When a dry cleaner is identified, the server 206 then alerts the dry cleaner via the dry cleaner's mobile device 208 to let them know they have been matched with a laundry client.

A dry cleaner thus also accesses the service platform using a mobile device 208 (which, as mentioned above, can alternatively be any network-enabled computing device), and when the server 206 identifies that dry cleaner as a good fit for the laundry client (e.g., based on the laundry client's preferences and dry cleaning parameters such as stain type and material), it alerts the dry cleaner of the laundry client's needs and connects the two. Connecting two users that the server 206 has matched together can include facilitating communication between the two users, either by allowing the users to directly communicate with each other or by allowing the users to communicate with each other using the server as a proxy to protect each user's privacy.

When the service platform has identified a dry cleaner for a laundry client, the laundry client can then either drop off their dry cleaning with the dry cleaner themselves, or the service platform can additionally coordinate for a driver to act as a courier—similar to when a laundry client needs a washer. When a laundry client has set a preference to identify that they prefer to have their dry cleaning picked up and dropped off by a driver, the server 206 can, in some embodiments, additionally identify a nearby driver (e.g., according to the laundry client's preferences, if applicable) that can pick up the laundry client's dry cleaning and deliver it to the identified dry cleaner.

After the dry cleaner has finished with the laundry client's dry cleaning, the dry cleaner can send information to the server 206 sufficient to indicate that the dry cleaning is done and available for pickup. In some embodiments, the server 206 can relay that status back to the laundry client. If the laundry client has set a preference indicating a desire for the completed dry cleaning to be picked up to be delivered back to the laundry client, then the server 206 can immediately (e.g., upon receiving an indication that the dry cleaner is done) begin to identify a new driver that can pick up the dry cleaning from the dry cleaner for delivery back to the laundry client. In some embodiments, the server 206 can deliver a message to the laundry client's device (e.g., 200, 202, or 204) indicating that the dry cleaning has been completed and give the laundry client a list of options for retrieving the dry cleaning, including delivery by driver or retrieval by the laundry client. The laundry client can then make a selection that is relayed back to the server 206, and the server 206 can alert the dry cleaner of the laundry client's selection (e.g., by sending a message to the dry cleaner's device 208) and react accordingly (e.g., by identifying a new driver to pick up and then drop the dry cleaning off with the laundry client or by simply letting the dry cleaner know that the laundry client will be coming to get their dry cleaning).

In another scenario, a laundry client needs a garment altered (e.g., a hem or the like). The steps undertaken are largely the same as in the scenarios above. In such a situation, the laundry client accesses the service platform via a computing device such as a mobile phone (e.g., mobile phone 200 as shown in FIG. 2). The laundry client can then provide an input to the service platform (e.g., server 206) via their mobile phone 200 indicating that they are looking for a nearby alterations provider. The laundry client's inputs are relayed from the user's device (e.g., 200, 202, or 204) to a server 206 so that the server 206 can conduct a search based on the laundry client's preferences to identify an alterations provider that best fits the laundry client's needs. In some embodiments, when the laundry client identifies that they need an alterations provider, the server 206 can send one or more questions to the laundry client's device (e.g., 200, 202, or 204) to collect additional information (e.g., what type of alteration is needed, what type of material is being altered, what color is the garment, how quickly does the laundry client need the alteration completed, etc.). When an alterations provider is identified, the server 206 then alerts the alterations provider via the alterations provider's mobile device 208 to let them know they have been matched with a laundry client.

An alterations provider thus also accesses the service platform using a mobile device 208 (which, as mentioned above, can alternatively be any network-enabled computing device), and when the server 206 identifies that alterations provider as a good fit for the laundry client (e.g., based on the laundry client's preferences and alteration parameters such as the needed alteration, the material, the color, etc.), it alerts the alterations provider of the laundry client's needs and connects the two. Connecting two users that the server 206 has matched together can include facilitating communication between the two users, either by allowing the users to directly communicate with each other or by allowing the users to communicate with each other using the server as a proxy to protect each user's privacy.

When the service platform has identified an alterations provider for a laundry client, the laundry client can then either drop off their garment with the alterations provider themselves, or the service platform can additionally coordinate for a driver to act as a courier—similar to when a laundry client needs a washer. When a laundry client has set a preference to identify that they prefer to have their garment picked up and dropped off by a driver, the server 206 can, in some embodiments, additionally identify a nearby driver (e.g., according to the laundry client's preferences, if applicable) that can pick up the laundry client's garment and deliver it to the identified alterations provider.

After the alterations provider has finished with the laundry client's garment, the alterations provider can send information to the server 206 sufficient to indicate that the alteration is done and the garment is available for pickup. In some embodiments, the server 206 can relay that status back to the laundry client. If the laundry client has set a preference indicating a desire for the completed garment to be picked up to be delivered back to the laundry client, then the server 206 can immediately (e.g., upon receiving an indication that the alterations provider is done) begin to identify a new driver that can pick up the garment from the alterations provider for delivery back to the laundry client. In some embodiments, the server 206 can deliver a message to the laundry client's device (e.g., 200, 202, or 204) indicating that the garment has been completed and give the laundry client a list of options for retrieving the laundry, including delivery by driver or retrieval by the laundry client. The laundry client can then make a selection that is relayed back to the server 206, and the server 206 can alert the alterations provider of the laundry client's selection (e.g., by sending a message to the alterations provider's device 208) and react accordingly (e.g., by identifying a new driver to pick up and then drop the garment off with the laundry client or by simply letting the alterations provider know that the laundry client will be coming to get their garment).

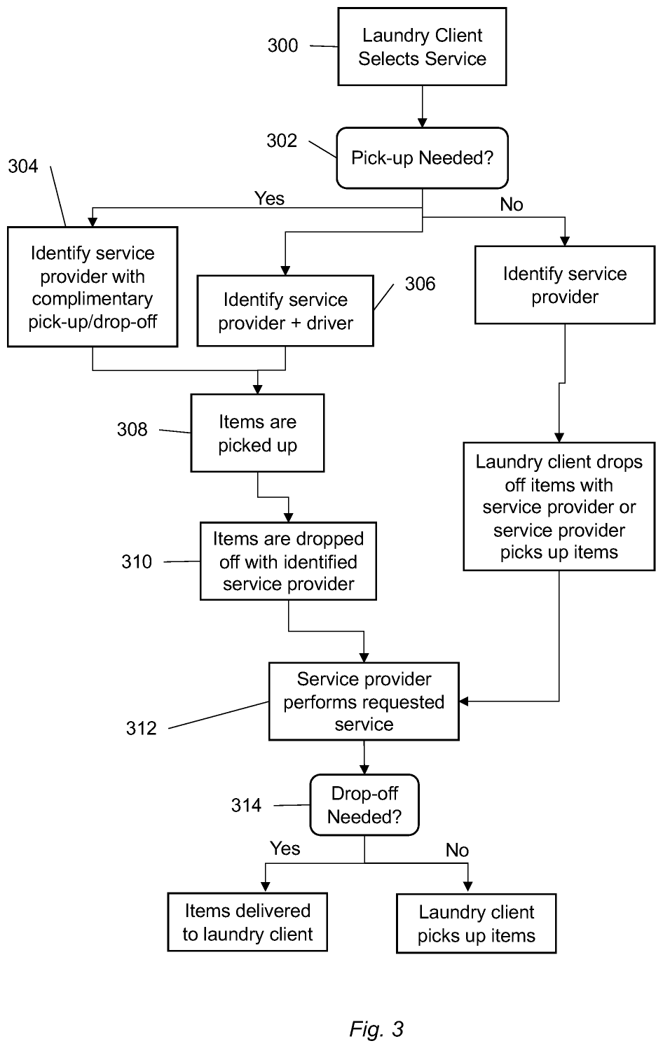

Each above-described examples of the inventive subject matter can be described in the context of FIG. 3. FIG. 3 shows a flowchart for different use cases centered on functionality from the perspective of a laundry client. In a first step 300, a laundry client selects a service they are in need of, e.g., alteration, dry cleaning, or laundry washing. The service platform then determines whether pick-up or drop-off is needed in step 302. Determining whether pick-up or drop-off are needed can be accomplished by prompting the laundry client for an input (e.g., “Do you need pick-up or drop-off service for your garments?”), but in some embodiments a laundry client can simply change a setting before even indicating what service is needed indicating that they always prefer a pick-up and drop-off for all or some subset of services. In other words, whether a driver is requested can be different depending on the requested service and the laundry client's user settings.

When the service platform has information regarding a laundry client's pick-up or drop-off preference, it can identify a service provider using that information. When a laundry client indicates they need pick-up or drop-off services, the service platform moves to steps 304 or 306. In step 304, the service platform identifies a service provider that offers complimentary pick-up and drop-off services. In step 306, the service platform identifies a service provider that does not offer pick-up or drop-off services and to address that gap it also identifies a driver that can perform at least the pick-up portion of the service. Thus, in instances where a driver is needed (e.g., because an alteration provider does not have any pick-up or drop-off service), the service platform can identify a driver and a service provider. The service provider can be, e.g., a washer, a dry cleaner, an alterations provider, etc.

Identifying a service provider (e.g., regardless of whether a driver is needed) can involve identifying a second user that has set preferences or criteria that match the needs of the laundry client (e.g., according to inputs from the laundry client that can indicate the type of service needed, distance to service, etc.). Steps described in FIG. 3 do not necessarily need to occur in the order presented. In some embodiments, the step of identifying a service provider can be accomplished before determining whether a laundry client needs pick-up or drop-off services. Thus, a driver can be identified after identifying service provider (e.g., some drivers may have ranges or regions selected and if a service provider is identified after identifying a driver, and that service provider is outside of the driver's range or region, then the driver would be incompatible for the task at hand). Similarly, a service provider can be identified based on, e.g., proximity to the laundry client, and then if the service provider has pick-up or drop-off services, no driver would be needed at all. Thus, in some embodiments, a service provider is identified before determining whether pick-up or drop-off are needed to ensure that the both service provider and the laundry client are in locations that comply with user settings for all users involved.

When a driver is requested, the driver can then come pick up the laundry client's items (e.g., garments for alteration or dry cleaning, or their dirty laundry) according to step 308. The driver can pick up items from whatever location the laundry client set when they requested a service (e.g., a GPS location based on the location of the laundry client's mobile device or a location that is manually set by the client). The driver then takes the laundry client's items to the service provider (step 310) where the service provider performs the requested service (step 312).

Once the service provider has completed the laundry client-requested services, the service provider transmits an indication to the service platform indicating the work is completed, and the service platform can then relay that information to the laundry client. The service platform can also, according to step 314, determine whether the laundry client is in need of a drop-off services to return the laundry client's items (this step can be carried out in the same way as steps 302, 304, & 306 above, except there will be no need to identify a service provider at this stage). If the laundry client indicates they would like drop-off service, then the service platform can either indicate to the service provider that a drop-off is requested, or the service platform can identify a driver to go to the service provider, retrieve the items, and then drop the items off with the laundry client. The laundry client's location at the time of drop off can be the same as the pick-up location, but in some embodiments, the laundry client can change locations and update their location with the service platform so that the driver knows where to take the laundry client's items.

Thus, specific systems and methods directed to a peer-to-peer laundry-based service platform have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A peer-to-peer laundryshare service platform, comprising:
a server storing computer code, wherein, upon execution, the computer code configures the server to:
receive first user preferences associated with a first user, the first user parameters comprising a required task;
receive second user preferences associated with a second user, the second user parameters comprising a set of task capabilities;
receive a request from the first user to connect with another user based on the first user preferences;
identify the second user as a match for the first user based on at least the required task and the set of task capabilities;
send a first communication to the first user, the first communication comprising a first indication that the second user and the first user have matching parameters;
send a second communication to the second user, the second communication comprising a second indication that the second user and the first user have matching parameters;
facilitate communication between the first user and the second user;
receive a third indication from the second user that the required task has been completed; and
send a fourth indication to the first user that the required task has been completed.

2. The platform of claim 1, wherein the first user is a laundry client.

3. The platform of claim 1, wherein the second user is a washer.

4. The platform of claim 1, wherein the second user is an alteration provider.

5. The platform of claim 1, wherein the second user is a dry cleaner.

6. The platform of claim 1, wherein upon executing the computer code, the server is further configured to:
receive, from the first user, a request to create an account comprising at least one of an email and a phone number;
send, to at least one of the email and the phone number, a verification code;
receive, from the first user, the verification code; and
verify authenticity of the first user based on receipt of the verification code.

7. A method of peer-to-peer laundryshare service platform, comprising:
receiving, by a server, first user preferences associated with a first user, the first user parameters comprising a required task;
receiving, by the server, second user preferences associated with a second user, the second user parameters comprising a set of task capabilities;
receiving, by the server, a request from the first user to connect with another user based on the first user preferences;
identifying, by the server, the second user as a match for the first user based on at least the required task and the set of task capabilities;
sending, from the server, a first communication to the first user, the first communication comprising a first indication that the second user and the first user have matching parameters;
sending, from the server, a second communication to the second user, the second communication comprising a second indication that the second user and the first user have matching parameters;
facilitating, by the server, communication between the first user and the second user;
receiving, by the server, a third indication from the second user that the required task has been completed; and
sending, by the server, a fourth indication to the first user that the required task has been completed.

8. The method of claim 7, wherein the first user is a laundry client.

9. The method of claim 7, wherein the second user is a washer.

10. The method of claim 7, wherein the second user is an alteration provider.

11. The method of claim 7, wherein the second user is a dry cleaner.

12. The method of claim 7, further comprising the steps of:
receiving, by the server from the first user, a request to create an account comprising at least one of an email and a phone number;
sending, to at least one of the email and the phone number, a verification code;
receiving, at the server from the first user, the verification code; and
verifying, by the server, authenticity of the first user based on receipt of the verification code.
